(19) United States
(12) Patent Application Publication
(10) Pub. No.: US 2019/0202040 A1
(43) Pub. Date: Jul. 4, 2019

(54) PUSH FITTING TUBING REMOVER

(71) Applicant: Kwon J. PARK, Diamond Bar, CA (US)

(72) Inventor: Kwon J. PARK, Diamond Bar, CA (US)

(21) Appl. No.: 15/859,261

(22) Filed: Dec. 29, 2017

(51) Int. Cl. B25B 27/02

(52) U.S. Cl. CPC B25B 27/02

(57) ABSTRACT

A push fitting tubing remover is provided, comprising a locking grip wrench portion, and upper and lower disassembly clip portion. The locking grip wrench portion has an upper jaw portion and a lower jaw portion. The upper disassembly clip portion extends from the upper jaw portion of the locking grip wrench portion and has a first circular groove portion having a first diameter and a first thickness configured to enclose a first cylindrical object. The lower disassembly clip portion extends from the lower jaw portion of the locking grip wrench portion and has a second circular groove portion having a second diameter and a second thickness. The upper disassembly clip portion and the lower disassembly clip portion are parallel when gripping the first and second cylindrical objects with a gap therebetween. The upper and lower disassembly clip portions are configured to disassemble a tubing from a push fitting connector.

### BACKGROUND OF THE INVENTION

The present invention relates to a push fitting tubing remover.

Sharkbite-style push fitting connectors are almost revolutionary in connecting pipes or tubes in the field of plumbing.

However, sometimes, it has been challenging to deal with the sharkbite-style push fitting connectors and the tubings. Also, the situations with crowded or narrow space has made it aggravated still further.

Accordingly, a need for a push fitting tubing remover has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a push fitting tubing remover.

An aspect of the invention provides a push fitting tubing remover comprising a locking grip wrench portion, an upper disassembly clip portion, and a lower disassembly clip portion.

The locking grip wrench portion has an upper jaw portion and a lower jaw portion in addition to a movable handle and a fixed handle with a locking device on it.

The upper disassembly clip portion extends from the upper jaw portion of the locking grip wrench portion and has a first circular groove portion having a first diameter and a first thickness configured to enclose a portion of a first cylindrical object.

The lower disassembly clip portion extends from the lower jaw portion of the locking grip wrench portion and has a second circular groove portion having a second diameter and a second thickness configured to enclose a portion of a second cylindrical object.

The upper disassembly clip portion and the lower disassembly clip portion are configured to be substantially parallel when gripping the first and second cylindrical objects with a gap there between.

The first diameter is different from the second diameter, and the first thickness is different from the second thickness.

The upper disassembly clip portion and the lower disassembly clip portion are configured to disassemble a tubing from a push fitting connector.

The locking grip wrench portion may be configured to close up on and grip a portion of the first or second cylindrical object between the upper and lower disassembly clips and to be locked so as to maintain gripping of the upper and lower disassembly clips in place.

The first or second cylindrical object may comprise a tubing or a neck portion of a push fitting connector.

The first diameter of the upper disassembly clip portion may be configured to enclose a portion of an outer surface of one of the tubing and the neck portion of the push fitting connector, and the second diameter of the lower disassembly clip portion may be configured to enclose a portion of an outer surface of the other of the tubing and the neck portion of the push fitting connector.

The first thickness of the upper disassembly clip portion may be configured to fit in a portion of an outer surface of one of the tubing and the neck portion of the push fitting connector, and the second thickness of the lower disassembly clip portion may be configured to fit in a portion of an outer surface of the other of the tubing and the neck portion of the push fitting connector.

The first thickness may be different from the second thickness.

The upper disassembly clip portion may extend in a direction of the upper jaw portion of the locking grip wrench portion, and the lower disassembly clip portion may extend in a direction of the lower jaw portion of the locking grip wrench portion.

The upper disassembly clip portion may be formed integrally with the upper jaw portion of the locking grip wrench portion, and the lower disassembly clip portion may be formed integrally with the lower jaw portion of the locking grip wrench portion.

Alternatively, the upper disassembly clip portion may be fixed to the upper jaw portion through two or more fastening devices, and the lower disassembly clip portion may be fixed to the lower jaw portion through two or more fastening devices.

Each of the two or more fastening devices may comprise bolts and nuts, which are disposed and connected through two or more through-holes provided at corresponding locations through the upper or lower disassembly clip portion and the upper or lower jaw portion.

The push fitting tubing remover may further comprise a male channel provided on the disassembly clip portion and a female channel provided on the jaw portion and configured to fit the male channel in a direction of the disassemly clip portion.

The male channel may have a cross-section with an overhang protruding portion at a vertical top, and the female channel may have a cross-section with an overhang receding portion at a bottom of a vertical bottom.

In another embodiment of the invention, the upper disassembly clip portion may extend in a direction perpendicular to the upper jaw portion of the locking grip wrench portion, and the lower disassembly clip portion may extend in a direction perpendicular to the lower jaw portion of the locking grip wrench portion.

The upper disassembly clip portion may be formed integrally with the upper jaw portion of the locking grip wrench portion, and the lower disassembly clip portion may be formed integrally with the lower jaw portion of the locking grip wrench portion.

Alternatively, the upper disassembly clip portion may be fixed to the upper jaw portion through two or more fastening devices, and the lower disassembly clip portion may be fixed to the lower jaw portion through two or more fastening devices.

Each of the two or more fastening devices may comprise bolts and nuts, which are disposed and connected through two or more through-holes provided at corresponding locations through the upper or lower disassembly clip portion and the upper or lower jaw portion.

The push fitting tubing remover may further comprise a male channel provided on the disassembly clip portion and a female channel provided on the jaw portion and configured to fit the male channel in a direction of the disassemly clip portion.

The male channel may have a cross-section with an overhang protruding portion at a vertical top, and the female channel may have a cross-section with an overhang receding portion at a bottom of a vertical bottom.

At least two of the two or more fastening devices may be disposed so as to be aligned in a direction of the upper or lower disassembly clip portion.

Alternatively, at least two of the two or more fastening devices may be disposed so as to be aligned in a direction perpendicular to the upper or lower disassembly clip portion.

The advantages of the present invention are: (1) the push fitting tubing remover according to the invention enables a plumber handle the situations with a single hand or hand-free; and (2) the push fitting tubing remover according to the invention can take care of several complicated situations with respect to sizes of the tubing and the sharkbite-style push fitting connectors.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view showing a conventional tubing remover for a sharkbite-style push fitting connectors according to a prior art;

FIG. 2 is a perspective view showing another conventional tubing remover for a sharkbite-style push fitting connectors according to prior arts;

FIG. 3 is a perspective view showing a conventional tubing remover used for an unfit-sized sharkbite-style push fitting connector according to prior arts;

FIG. 4 is a perspective view showing a push fitting tubing remover deployed across a push fitting connector and a tubing according to an embodiment of the invention;

FIG. 5 is a perspective view showing the push fitting tubing remover in FIG. 4;

FIG. 6 is a perspective view showing a push fitting tubing remover deployed across a push fitting connector and a tubing according to another embodiment of the invention;

FIG. 7 is a perspective view showing the push fitting tubing remover in FIG. 6;

FIG. 8 is a perspective view showing a sharkbite-style push fitting connector according to prior arts;

FIG. 9 shows top views of an upper disassembly clip portion fixed to an upper jaw portion for a straight installment (A) and a perpendicular installment (B) according to an embodiment of the invention;

FIG. 10 shows top views of an upper disassembly clip portion about to be fixed to an upper jaw portion through male and female channels for a straight installment (A) and a perpendicular installment (B) according to an embodiment of the invention; and

FIG. 11 is a cross-sectional view showing an upper disassemly clip portion and an upper jaw portion along the lines XI and Q in FIG. 10(A) overlapped to be fixed according to an embodiment of the invention.

### DETAILED DESCRIPTION EMBODIMENTS OF THE INVENTION

Referring to the figures, the embodiments of the invention are described in detail.

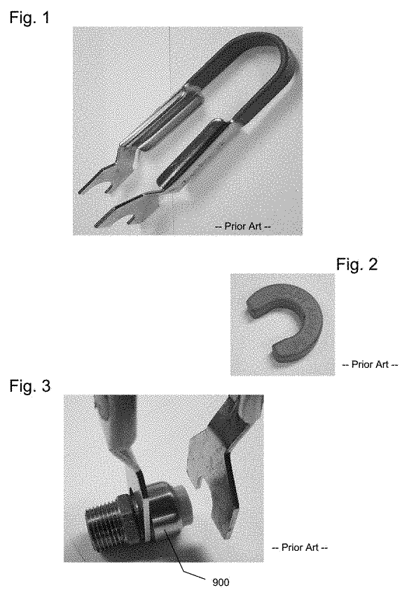

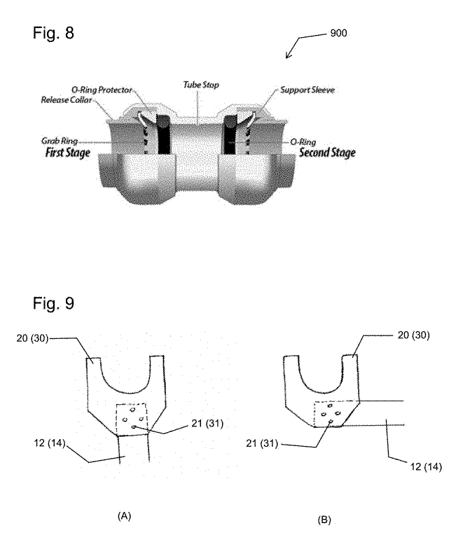

FIGS. 1-3 shows conventional tubing removers and a usage according to a prior art. FIG. 8 shows a sharkbite-style push fitting connector according to prior arts.

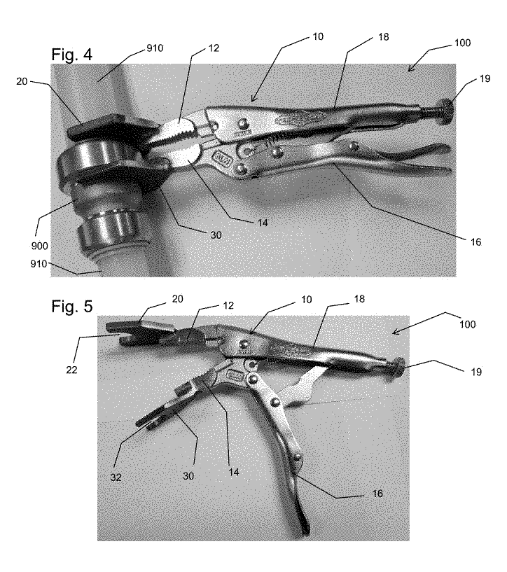

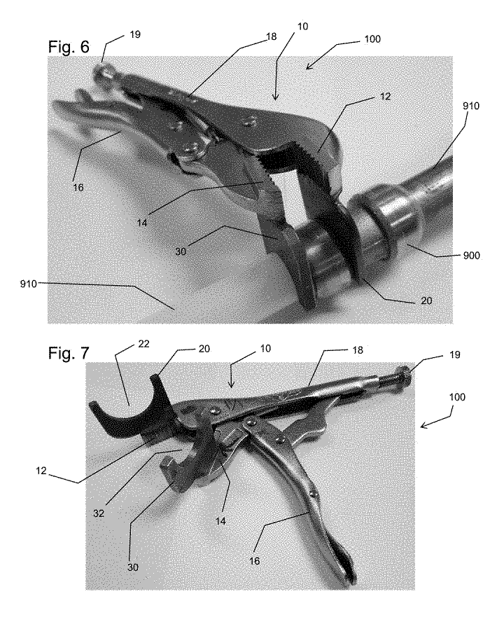

FIGS. 4 and 5 show a push fitting tubing remover deployed across a push fitting connector and a tubing according to an embodiment of the invention. FIGS. 6 and 7 show a push fitting tubing remover deployed across a push fitting connector and a tubing according to another embodiment of the invention.

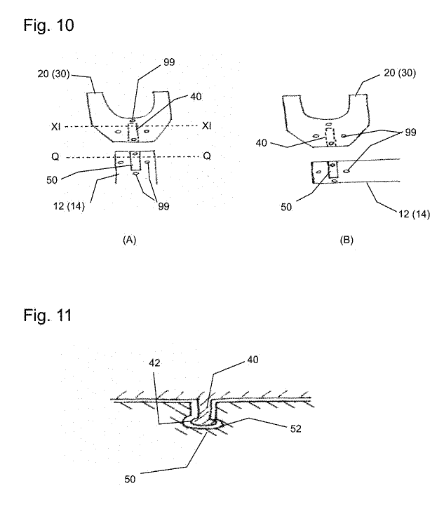

FIGS. 9 and 10 show top views of an upper disassembly clip portion fixed to an upper jaw portion for a straight installment (A) and a perpendicular installment (B) according to embodiments of the invention. FIG. 11 shows a cross-sectional view showing an upper disassemly clip portion and an upper jaw portion along the lines XI and Q in FIG. 10(A) overlapped to be fixed according to an embodiment of the invention.

FIG. 8 shows a sharkbite-style push fitting connector (900) according to prior arts, which includes a tube stop, a grab ring, an O-ring, an O-ring protector, a release collar, and a support sleeve. A tubing can be pushed in, stopped by the O-ring, and grabbed by the grab ring. The tubing can be removed by pushing the release collar with removers shown in FIGS. 1 and 2.

However, the tubing removers shown in FIGS. 1 and 2 are very specific according to manufacturers of sharkbite-style push fitting connectors and sizes of the connectors and the tubings. Therefore, one tubing remover would be useless most probably when the manufacturers and sizes of related connectors or tubings are different as shown in FIG. 3.

An aspect of the invention provides a push fitting tubing remover (100) comprising a locking grip wrench portion (10), an upper disassembly clip portion (20), and a lower disassembly clip portion (30).

The locking grip wrench portion (10) has an upper jaw portion (12) and a lower jaw portion (14) in addition to a movable handle (16) and a fixed handle (18) with a locking device (19) on it as shown in FIGS. 4-7.

The upper disassembly clip portion (20) extends from the upper jaw portion (12) of the locking grip wrench portion (10) and has a first circular groove portion (22) having a first diameter and a first thickness configured to enclose a portion of a first cylindrical object (910).

The lower disassembly clip portion (30) extends from the lower jaw portion (14) of the locking grip wrench portion (10) and has a second circular groove portion (32) having a second diameter and a second thickness configured to enclose a portion of a second cylindrical object (910).

The upper disassembly clip portion (20) and the lower disassembly clip portion (30) are configured to be substantially parallel when gripping the first and second cylindrical objects (910) with a gap there between as shown in FIGS. 4 and 6.

The first diameter is different from the second diameter, and the first thickness is different from the second thickness as shown in FIGS. 4-7.

The upper disassembly clip portion (20) and the lower disassembly clip portion (30) are configured to disassemble a tubing (910) from a push fitting connector (900) as shown in FIGS. 4 and 6.

The locking grip wrench portion (10) may be configured to close up on and grip a portion of the first or second cylindrical object (910) between the upper and lower disassembly clip portions (20, 30) and to be locked so as to maintain gripping of the upper and lower disassembly clip portions (20, 30) with respect to the connector (900) in place.

The first or second cylindrical object (910) may comprise a tubing or a neck portion of a push fitting connector (900). The tubing may include copper tubing, PEX tubing, PVC tubing, CPVC tubing, and poly tubing.

The first diameter of the upper disassembly clip portion (20) may be configured to enclose a portion of an outer surface of one of the tubing (910) and the neck portion of the push fitting connector (900), and the second diameter of the lower disassembly clip portion (30) may be configured to enclose a portion of an outer surface of the other of the tubing (910) and the neck portion of the push fitting connector (900).

The first thickness of the upper disassembly clip portion (20) may be configured to fit in a portion of an outer surface of one of the tubing (910) and the neck portion of the push fitting connector (900), and the second thickness of the lower disassembly clip portion (30) may be configured to fit in a portion of an outer surface of the other of the tubing (910) and the neck portion of the push fitting connector (900).

The first thickness may be different from the second thickness. The variation of the first or second thickness can be determined by the environmental dimension such as the space around the neck portion of the connector (900) as shown in FIGS. 4 and 6.

The upper disassembly clip portion (20) may extend in a direction of the upper jaw portion (12) of the locking grip wrench portion (10), and the lower disassembly clip portion (30) may extend in a direction of the lower jaw portion (14) of the locking grip wrench portion (10) as shown in FIGS. 4 and 5.

The upper disassembly clip portion (10) may be formed integrally with the upper jaw portion (12) of the locking grip wrench portion (10), and the lower disassembly clip portion (30) may be formed integrally with the lower jaw portion (14) of the locking grip wrench portion (10) by a method such as welding, for example.

Alternatively, the upper disassembly clip portion (20) may be fixed to the upper jaw portion (12) through two or more fastening devices (21), and likewise the lower disassembly clip portion (30) may be fixed to the lower jaw portion (14) through two or more fastening devices (31) as shown in FIG. 9.

Each of the two or more fastening devices (21, 31) may comprise bolts and nuts, which are disposed and connected through two or more through-holes (99) provided at corresponding locations through the upper or lower disassembly clip portion (20, 30) and the upper or lower jaw portion (12, 14) as shown in FIG. 10. Each of the disassembly clip portions (20, 30) and the jaw portions (12, 14) includes four through-holes (99) in the illustrated embodiments in FIGS. 9 and 10.

The push fitting tubing remover (100) may further comprise a male channel (40) provided on the disassembly clip portion (20, 30) and a female channel (50) provided on the jaw portion (12, 14) and configured to fit the male channel (40) in a direction of the disassemly clip portion (20, 30) as shown in FIG. 10.

The male channel (40) may have a cross-section with an overhang protruding portion (42) at a vertical top, and the female channel (50) may have a cross-section with an overhang receding portion (52) at a bottom of a vertical bottom as shown in FIG. 11. In the illustrated embodiment, the gap between the portions (40, 50) has been exaggerated to show the structure clearly. The exact shape of the overhang portions (42, 52) can be adjusted to make the installment sturdy and stable.

In another embodiment of the invention, the upper disassembly clip portion (20) may extend in a direction perpendicular to the upper jaw portion (12) of the locking grip wrench portion (10), and the lower disassembly clip portion (30) may extend in a direction perpendicular to the lower jaw portion (14) of the locking grip wrench portion (10) as shown in FIGS. 9(B) and 10(B).

The upper disassembly clip portion (20) may be formed integrally with the upper jaw portion (12) of the locking grip wrench portion (10), and the lower disassembly clip portion (20) may be formed integrally with the lower jaw portion (14) of the locking grip wrench portion (10).

Alternatively, the upper disassembly clip portion (20) may be fixed to the upper jaw portion (12) through two or more fastening devices (21), and the lower disassembly clip portion (30) may be fixed to the lower jaw portion through two or more fastening devices (31).

Each of the two or more fastening devices (21, 31) may comprise bolts and nuts, which are disposed and connected through two or more through-holes (99) provided at corresponding locations through the upper or lower disassembly clip portion (20, 30) and the upper or lower jaw portion (12, 14).

The push fitting tubing remover (100) may further comprise a male channel (40) provided on the disassembly clip portion (20, 30) and a female channel (50) provided on the jaw portion (12, 14) and configured to fit the male channel (50) in a direction of the disassemly clip portion (20, 30).

The male channel (40) may have a cross-section with an overhang protruding portion (42) at a vertical top, and the female channel (50) may have a cross-section with an overhang receding portion (52) at a bottom of a vertical bottom.

At least two of the two or more fastening devices (21, 31) may be disposed so as to be aligned in a direction of the upper or lower disassembly clip portion (20, 30).

Alternatively, at least two of the two or more fastening devices (21, 31) may be disposed so as to be aligned in a direction perpendicular to the upper or lower disassembly clip portion (20, 30).

In the states of FIG. 4 or 6, the push fitting tubing remover (100) can be configured to grip the release collar of the connector (900) firmly against the connector (900) and then the tubing (910) can be removed easily.

Also, one of the disassembly clip portions (20, 30) can be used to enclose a portion of tube at a connecting portion and be hit by a hammer to separate them.

Since the disassembly clip portions (20, 30) can be easily replaced with another one with different sizes and thicknesses from the upper or lower jaw portion (12, 14), the environment can be accommodated conveniently accordingly.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A push fitting tubing remover comprising:
a locking grip wrench portion having an upper jaw portion and a lower jaw portion;
an upper disassembly clip portion extending from the upper jaw portion of the locking grip wrench portion and having a first circular groove portion having a first diameter and a first thickness configured to enclose a portion of a first cylindrical object; and
a lower disassembly clip portion extending from the lower jaw portion of the locking grip wrench portion and having a second circular groove portion having a second diameter and a second thickness configured to enclose a portion of a second cylindrical object,
wherein the upper disassembly clip portion and the lower disassembly clip portion are configured to be substantially parallel when gripping the first and second cylindrical objects with a gap there between,
wherein the first diameter is different from the second diameter,
wherein the first thickness is different from the second thickness, and
wherein the upper disassembly clip portion and the lower disassembly clip portion are configured to disassemble a tubing from a push fitting connector.

2. The push fitting tubing remover of claim 1, wherein the locking grip wrench portion is configured to close up on and grip a portion of the first or second cylindrical object between the upper and lower disassembly clips and to be locked so as to maintain gripping of the upper and lower disassembly clips.

3. The push fitting tubing remover of claim 2, wherein the first or second cylindrical object comprises a tubing or a neck portion of a push fitting connector.

4. The push fitting tubing remover of claim 3, wherein the first diameter of the upper disassembly clip portion is configured to enclose a portion of an outer surface of one of the tubing and the neck portion of the push fitting connector, and wherein the second diameter of the lower disassembly clip portion is configured to enclose a portion of an outer surface of the other of the tubing and the neck portion of the push fitting connector.

5. The push fitting tubing remover of claim 3, wherein the first thickness of the upper disassembly clip portion is configured to fit in a portion of an outer surface of one of the tubing and the neck portion of the push fitting connector, and wherein the second thickness of the lower disassembly clip portion is configured to fit in a portion of an outer surface of the other of the tubing and the neck portion of the push fitting connector.

6. The push fitting tubing remover of claim 5, wherein the first thickness is different from the second thickness.

7. The push fitting tubing remover of claim 3, wherein the upper disassembly clip portion extends in a direction of the upper jaw portion of the locking grip wrench portion, and wherein the lower disassembly clip portion extends in a direction of the lower jaw portion of the locking grip wrench portion.

8. The push fitting tubing remover of claim 7, wherein the upper disassembly clip portion is formed integrally with the upper jaw portion of the locking grip wrench portion, and wherein the lower disassembly clip portion is formed integrally with the lower jaw portion of the locking grip wrench portion.

9. The push fitting tubing remover of claim 7, wherein the upper disassembly clip portion is fixed to the upper jaw portion through two or more fastening devices, and wherein the lower disassembly clip portion is fixed to the lower jaw portion through two or more fastening devices.

10. The push fitting tubing remover of claim 9, wherein each of the two or more fastening devices comprises bolts and nuts, which are disposed and connected through two or more through-holes provided at corresponding locations through the upper or lower disassembly clip portion and the upper or lower jaw portion.

11. The push fitting tubing remover of claim 10, further comprising:
a male channel provided on the disassembly clip portion; and
a female channel provided on the jaw portion and configured to fit the male channel in a direction of the disassemly clip portion.

12. The push fitting tubing remover of claim 11, wherein the male channel has a cross-section with an overhang protruding portion at a vertical top, and wherein the female channel has a cross-section with an overhang receding portion at a bottom of a vertical bottom.

13. The push fitting tubing remover of claim 3, wherein the upper disassembly clip portion extends in a direction perpendicular to the upper jaw portion of the locking grip wrench portion, and wherein the lower disassembly clip portion extends in a direction perpendicular to the lower jaw portion of the locking grip wrench portion.

14. The push fitting tubing remover of claim 13, wherein the upper disassembly clip portion is formed integrally with the upper jaw portion of the locking grip wrench portion, and wherein the lower disassembly clip portion is formed integrally with the lower jaw portion of the locking grip wrench portion.

15. The push fitting tubing remover of claim 13, wherein the upper disassembly clip portion is fixed to the upper jaw portion through two or more fastening devices, and wherein the lower disassembly clip portion is fixed to the lower jaw portion through two or more fastening devices.

16. The push fitting tubing remover of claim 15, wherein each of the two or more fastening devices comprises bolts and nuts, which are disposed and connected through two or more through-holes provided at corresponding locations through the upper or lower disassembly clip portion and the upper or lower jaw portion.

17. The push fitting tubing remover of claim 15, further comprising:
a male channel provided on the disassembly clip portion; and
a female channel provided on the jaw portion and configured to fit the male channel in a direction of the disassemly clip portion.

18. The push fitting tubing remover of claim 17, wherein the male channel has a cross-section with an overhang protruding portion at a vertical top, and wherein the female channel has a cross-section with an overhang receding portion at a bottom of a vertical bottom.

19. The push fitting tubing remover of claim 15, wherein at least two of the two or more fastening devices are disposed so as to be aligned in a direction of the upper or lower disassembly clip portion.

20. The push fitting tubing remover of claim 15, wherein at least two of the two or more fastening devices are disposed so as to be aligned in a direction perpendicular to the upper or lower disassembly clip portion.
